(19) United States
(12) Patent Application Publication
(10) Pub. No.: US 2014/0008972 A1
(43) Pub. Date: Jan. 9, 2014

(54) ELECTRICAL POWER SUPPLY FOR AN AIRCRAFT

(71) Applicants: Eric De Wergifosse, Saint Augustin (FR); Julien Rambaud, Echarcon (FR); Sebastien Vieillard, La Chapelle Gauthier (FR)

(72) Inventors: Eric De Wergifosse, Saint Augustin (FR); Julien Rambaud, Echarcon (FR); Sebastien Vieillard, La Chapelle Gauthier (FR)

(73) Assignee: HISPANO-SUIZA, Colombes (FR)

(21) Appl. No.: 14/005,674

(22) PCT Filed: Mar. 7, 2012
(86) PCT No.: PCT/FR12/50467

§ 371 Date: Sep. 17, 2013

(30) Foreign Application Priority Data
Mar. 17, 2011 (FR) 1152186

(51) Int. Cl. B60R 16/03

(52) U.S. Cl. CPC B60R 16/03
USPC 307/9.1

(57) ABSTRACT

A generation method performed by a generator module of an electricity network of an aircraft, the electricity network including a power supply line powered by the generator module, a DC bus powered from the power supply line via a rectifier, and at least one electrical actuator powered with AC from the DC bus via an inverter. The generation method includes: delivering an AC voltage as a function of a voltage setpoint and of a voltage measured in the on-board network; and determining the voltage setpoint as a function of an operating parameter of the actuator.

### BACKGROUND OF THE INVENTION

The invention relates to electrically powering a network that is dedicated to a piece of equipment of an aircraft.

It is known to power electricity networks on board an aircraft from an on-board generator. Typically, the generator is a generator connected to a propulsion engine of the aircraft or to an auxiliary power unit (APU) having a gas turbine.

In conventional manner, such a generator comprises a main electrical machine that forms a main electricity generator operating in synchronous mode after the associated turbine engine has been started and is running. The main electrical machine has an inducer rotor and stator windings that deliver alternating current (AC) power to a three-phase bus of an electricity network of the aircraft.

The dedicated network also has power supply equipment in which a direct current (DC) bus is powered from the AC voltage of the three-phase bus via a rectifier. The power supply equipment powers three-phase electrical actuators from the DC voltage of the DC bus via inverter type power converters.

The AC voltage of the three-phase bus or the DC voltage of the DC bus is controlled by means of a generator control unit (GCU) that delivers DC to a stator inducer of an exciter having rotor windings connected to the rotor inducer of the main electrical machine via a rotary rectifier. Typically, the control unit of the generator causes the excitation DC to vary in such a manner as to maintain the AC of the three-phase bus or the DC of the DC bus equal to a constant setpoint value. The electrical power needed for powering the inducer of the exciter may be delivered by an auxiliary electricity generator such as a permanent-magnet synchronous generator, or it may be derived from the on-board electricity network of the aircraft.

In an electricity network of this type, the inverter type power converters that power the actuators need to be dimensioned so as to accommodate both electrical and thermal stresses associated with the mechanical power that is needed for operating the actuator. Such power converters are generally pieces of equipment that are heavy and bulky.

### OBJECT AND SUMMARY OF THE INVENTION

The invention seeks to provide a generation method and a generator module that make it possible to avoid at least some of the drawbacks of the above-mentioned prior art.

To this end, the invention provides a generation method performed by a generator module of an electricity network of an aircraft, said electricity network comprising a power supply line powered by said generator module, a DC bus powered from said power supply line via a rectifier, and at least one electrical actuator powered with AC from the DC bus via an inverter;

the generation method comprising a step of delivering an AC voltage as a function of a voltage setpoint and of a voltage measured in said on-board network;

said generation method being characterized in that it comprises a step of determining said voltage setpoint as a function of an operating parameter of said actuator.

Thus, by means of these characteristics, the DC voltage of the DC bus depends on the operating parameter of the actuator. This makes it possible to limit the dimensioning of the inverter and/or to reduce the dissipation of the inverter.

In an implementation, said measured voltage is the voltage of the DC bus.

The operating parameter may be a speed of rotation of the actuator.

Correspondingly, the invention provides a generator module for an electricity network of an aircraft, said generator module being suitable for delivering an AC voltage as a function of a voltage setpoint and of a voltage measured in said electricity network, said electricity network comprising a power supply line powered by said generator module, a DC bus powered from said power supply line via a rectifier, and at least one electrical actuator powered with AC from the DC bus via an inverter;

said generator module being characterized in that it includes a module for determining said voltage setpoint as a function of an operating parameter of said actuator.

In an embodiment, the generator module comprises a generator and a generator control unit, the generator being suitable for delivering said AC voltage as a function of a control current determined by the generator control unit, the generator control unit being suitable for determining the control current as a function of the voltage setpoint and of the voltage measured in said on-board network.

The advantages and characteristics mentioned above with reference to the generation method also apply to the generator module.

The invention also provides an aircraft having an electricity network including a generator module of the invention, a power supply line powered by said generator module, a DC bus powered from said power supply line via a rectifier, and at least one electrical actuator powered with AC from the DC bus via an inverter.

### BRIEF DESCRIPTION OF THE DRAWING

The invention can be better understood on reading the following description made by way of non-limiting indication and with reference to the accompanying drawing, in which:

FIG. 1 is a diagram of an electricity network dedicated to powering power supply equipment on board an aircraft;

FIG. 2 is a graph showing an operating curve of an electrical actuator;

FIG. 3 is a graph showing electrical losses in a converter powering an actuator having the operating curve as shown in FIG. 2; and

FIGS. 4 and 5 are similar to FIGS. 2 and 3 respectively, and relate to another type of electrical actuator.

### DETAILED DESCRIPTION OF EMBODIMENTS

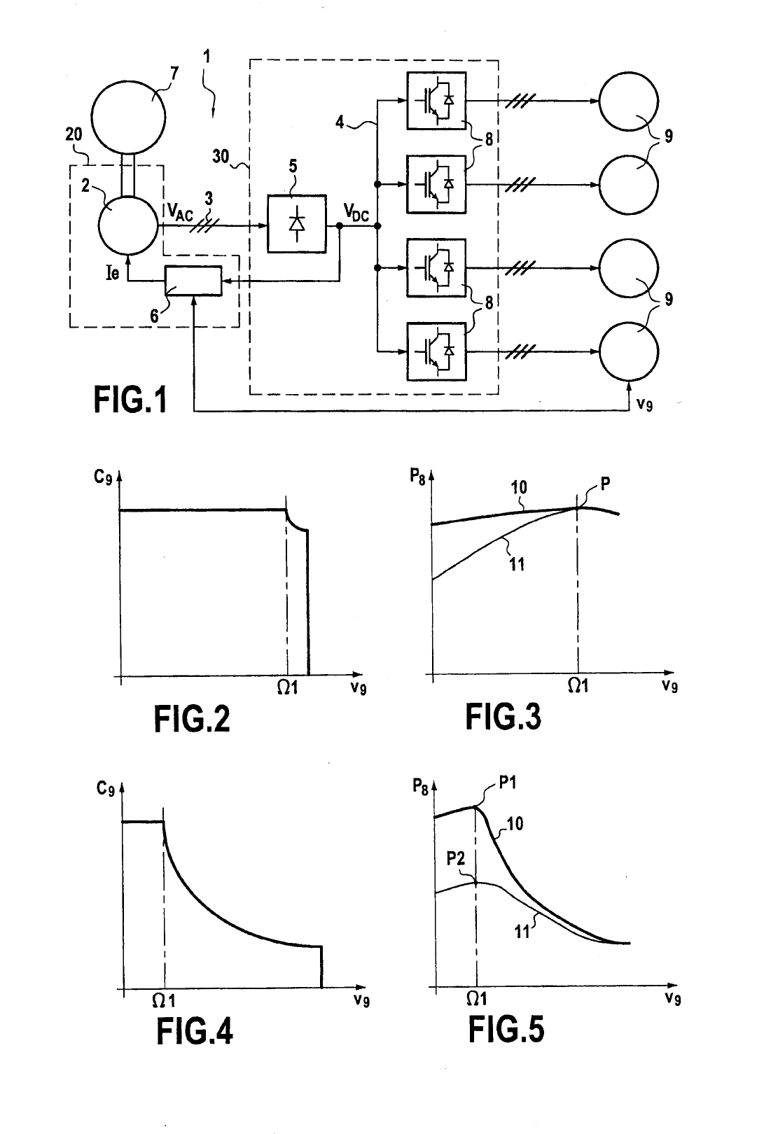

FIG. 1 shows the electricity network of an aircraft, in its environment. The electricity network 1 is a network dedicated to powering power supply equipment 30 and it comprises a generator module 20, the power supply equipment 30, and a three-phase power supply line 3 connecting the generator module 20 to the power supply equipment 30.

The generator module 20 delivers a three-phase voltage V_{AC}. In the example shown, the generator module 20 comprises a generator 2 and a generator control unit 6.

The generator 2 is mechanically connected to an engine 7 that may for example be an engine for providing propulsion or else an auxiliary power unit of the aircraft. The generator 2 may be a starter/generator suitable for operating as an electric motor when starting the engine 7.

When the generator 2 is driven in rotation by the engine 7, it delivers a three-phase voltage V_{AC} that depends on a control current Iₑ delivered by the generator control unit 6. By way of example, the generator 2 is a three-stage generator of the type described in the introduction.

The power supply line 3 is powered with the three-phase voltage _{AC} delivered by the generator 2.

The power supply equipment 30 has a DC bus 4, a rectifier 5, and inverters 8. The DC bus 4 is powered by a DC voltage V_{DC} from the three-phase voltage V_{AC} of the power supply line 3 via the rectifier 5.

Electrical actuators 9 are electrically powered by the power supply equipment 30. More precisely, each electrical actuator 9 is powered with a three-phase voltage from the DC bus 4 via an inverter 8. Each electrical actuator 9 is typically an electric motor of operation that may be characterized by a speed of rotation, written v₉, and by a torque, written C₉.

The generator control unit 6 receives measurement signals representative of the DC voltage V_{DC} of the DC bus 4 and of the speed of rotation v₉, and it delivers the control current Iₑ to the generator 2.

For this purpose, the generator control unit 6 uses a control loop in which the control current Iₑ is determined as a function of the DC voltage _{VDC} of the DC bus 4 and of a DC voltage setpoint V_{DC}_{_{—}}ₛₑₜ.

The setpoint V_{DC}_{_{—}}ₛₑₜ is determined by the generator control unit 6 as a function of the speed of rotation v₉. Thus, in the electricity network 1, the DC voltage V_{DC} of the DC bus 4 depends on the speed of rotation v₉, thereby making it possible to limit dissipation and to limit the dimensioning of the inverters 8, as explained below with reference to FIGS. 2 to 5.

It is known that the mechanical power Pₘ of an electrical actuator 9 may be expressed as follows: Pₘ=v₉×C₉. It is also known that the torque C₉ increases with the phase current I of the electrical actuator 9.

This mechanical power Pₘ corresponds to an absorbed electrical power Pₑ that is proportional to the product U₉×I, where U₉ is the voltage delivered to the actuator 9 by the inverter 8.

At a low speed of rotation v₉, and regardless of the torque C₉, the mechanical power Pₘ, and thus the absorbed electrical power Pₑ, are low. The voltage U₉ delivered to the actuator 9 by the inverter 8 can therefore be low.

FIG. 2 is a graph showing an operating curve for a first type of electrical actuator 9, plotting the torque C₉ as a function of the speed of rotation v₉. As shown in FIG. 2, the torque C₉ is practically at a maximum over the entire range of speeds up to a speed Ω₁.

FIG. 3 is a graph showing variation in the power P₈ that is dissipated in an inverter 8 connected to an electrical actuator 9, plotted as a function of the speed v₉, for an electrical actuator 9 of the type shown in FIG. 2. The curve 11 corresponds to a DC voltage V_{DC} that varies with the speed v₉ in accordance with the present invention. The curve 10 corresponds to a DC voltage VDC that is kept constant, as in the prior art mentioned in the introduction, and it is given for comparison purposes.

The power P₈ that is dissipated in an inverter 8 may be resolved into conduction losses and switching losses. Switching losses depend on the product V_{DC}×I. Given the curve in FIG. 2, the current I must be high in order to deliver a high torque C₉, regardless of the speed of rotation v₉. Thus, if V_{DC} is kept constant, the power P₈ is high even at a small speed of rotation v₉, as shown by curve 10.

Nevertheless, as explained above, the voltage U₉ may be small at a small speed of rotation v₉. However, the voltage U₉ depends on the DC voltage V_{DC}. If it is possible for the voltage U₉ to be low, then the DC voltage V_{DC} can also be low. Thus, by reducing the DC voltage V_{DC} at small speeds of rotation v₉, the power P₈ that is dissipated in an inverter 8 can be reduced in comparison with the curve 10, as shown by the curve 11.

In FIG. 3, the curves 10 and 11 meet at a point P at the speed Ω₁.

In other words, for an electrical actuator 9 that presents an operating curve of the type shown in FIG. 2, it is possible to determine a setpoint voltage V_{DC}_{_{—}}ₛₑₜ, on which the speed of rotation v₉ of the electrical actuators 9 depends, that makes it possible for the power P₈ that is dissipated in the inverter 8 to be reduced. Thus, the thermal dimensioning of the inverter 8 can be limited. Nevertheless, the electrical dimensioning of the inverter 8 must still make it possible to operate at the above-mentioned point P.

FIGS. 4 and 5 are graphs similar to the graphs of FIGS. 2 and 3 respectively, and they relate to a second type of electrical actuator 9 that presents an operating curve having a shape that is different, as shown in FIG. 4. FIGS. 4 and 5 use the same references, without risk of confusion.

In this embodiment, the torque C₉ is at a maximum at low speeds up to a speed Ω₁, and then decreases progressively over the remainder of the speed range.

As in the embodiment of FIGS. 2 and 3, the DC voltage V_{DC} may be small at low speeds of rotation. FIG. 5 shows that under such circumstances, the power P₈ that is dissipated in the inverter is reduced, as it is in FIG. 3 (cf. curve 11 situated below curve 10).

Furthermore, in this embodiment, the operating point P2, where the power P₈ given by the curve 11 is at a maximum, corresponds to a power that is less than the operating point P1, where the power P₈ given by the curve 10 is at a maximum.

In other words, with an electrical actuator 9 that presents an operating curve of the type shown in FIG. 4, it is possible to determine a setpoint V_{DC}_{_{—}}ₛₑₜ, on which the speed of rotation v₉ of the electrical actuators 9 depends, that enables the power P₈ that is dissipated in the inverter 8 to be reduced, and also to reduce the maximum dissipated power P₈. It is thus possible for the dimensioning of the inverter 8 to be limited, both thermally and electrically.

The generator control unit 6 has a determination module that converts the speed of rotation v₉ into a setpoint V_{DC}_{_{—}}ₛₑₜ. By way of example, the determination module uses a correspondence table or a conversion relationship. The person skilled in the art is capable of designing a determination module that is appropriate for a given operating curve, e.g. of the type shown in FIG. 2 or of the type shown in FIG. 4.

In a variant, instead of using the speed of rotation v₉, the generator control unit 6 makes use of some other operating parameter of the electrical actuator 9 in order to determine the setpoint V_{DC}_{_{—}}ₛₑₜ.

Also in a variant, the regulation performed by the generator control unit 6 applies to the three-phase voltage V_{AC} of the power supply line 3. Under such circumstances, the generator control unit 6 determines a three-phase voltage setpoint V_{AC}_{_{—}}ₛₑₜ that is a function of the speed v₉ or of some other operating parameter of the electrical actuator 9.

A generator module 20 is described above in which the three-phase voltage delivered by the generator 2 depends on the control current as determined by the control unit 6. Nevertheless, the invention is not limited to that type of generator module. Thus, the generator module may comprise a self-excited asynchronous generator associated with switched capacitors in order to provide a plurality of voltage levels. In a variant, the generator module may comprise a self-excited asynchronous generator associated with an inverter delivering magnetization current for DC regulation. Also in a variant, the generator module may comprise a multi-winding permanent-magnet synchronous generator for operating at a plurality of levels.

An example application for the electricity network 1 lies in green taxiing of an aircraft. In this example, the actuators 9 are electric motors suitable for enabling the aircraft to taxi and the engine 7 is an auxiliary power unit. The propulsion engines of the aircraft then do not need to be running, thus achieving significant fuel savings.

1-7. (canceled)

8. A generation method for generating a voltage, the method being performed by a generator module of an electricity network of an aircraft, the electricity network comprising a power supply line powered by the generator module, a DC bus powered from the power supply line via a rectifier, and at least one electrical actuator powered with AC from the DC bus via an inverter;
the generation method comprising:
delivering an AC voltage as a function of a voltage setpoint and of a voltage measured in the on-board network; and
determining the voltage setpoint as a function of an operating parameter of the actuator.

9. A generation method according to claim 8, wherein the measured voltage is voltage of the DC bus.

10. A generation method according to claim 8, wherein the operating parameter is a speed of rotation of the actuator.

11. A generation method according to claim 8, wherein the generator module comprises a generator and a generator control unit,
the generator configured to deliver the AC voltage as a function of a control current determined by the generator control unit, the generator control unit configured to determine the control current as a function of the voltage setpoint and of the voltage measured in the on-board network.

12. A voltage generator module for an electricity network of an aircraft, the generator module configured to deliver an AC voltage as a function of a voltage setpoint and of a voltage measured in the electricity network, the electricity network comprising a power supply line powered by the generator module, a DC bus powered from the power supply line via a rectifier, and at least one electrical actuator powered with AC from the DC bus via an inverter; wherein
the generator module comprises a module for determining the voltage setpoint as a function of an operating parameter of the actuator.

13. A generator module according to claim 12, further comprising a generator and a generator control unit,
the generator configured to deliver the AC voltage as a function of a control current determined by the generator control unit,
the generator control unit configured to determine the control current as a function of the voltage setpoint and of the voltage measured in the on-board network.

14. An aircraft comprising an electricity network comprising:
a generator module according to claim 12;
a power supply line powered by the generator module;
a DC bus powered from the power supply line via a rectifier; and
at least one electrical actuator powered with AC from the DC bus via an inverter.
